(19) United States
(12) Patent Application Publication
(10) Pub. No.: US 2016/0214188 A1
(43) Pub. Date: Jul. 28, 2016

(54) CUTTING DEVICE AND A METHOD FOR TREATING A PILE

(71) Applicant: MOTOCUT OY, Kerava (FI)

(72) Inventor: Teppei MORIMOTO, Kerava (FI)

(73) Assignee: MOTOCUT OY, Kerava (FI)

(21) Appl. No.: 15/085,238

(22) Filed: Mar. 30, 2016

Related U.S. Application Data
(63) Continuation of application No. PCT/FI2013/050946, filed on Sep. 30, 2013.

(51) Int. Cl. B23D 45/00; B23D 45/12

(52) U.S. Cl. CPC B23D 45/006; B23D 45/12

(57) ABSTRACT

A cutting device is disclosed for performing work actions to a pile, the cutting device having a body part for connecting the cutting device to a working machine. The cutting device can grip the pile using at least two opposite gripping parts to obtain a grip from different sides of the pile. A sawing device can perform a sawing action. The cutting device includes joint points of the opposite gripping parts, a distance between joint points, being alterable, and the gripping parts are moved by altering the distance between the joint points of the gripping parts to obtain desired contact areas between the gripping parts and the pile.

### RELATED APPLICATION

This application claims priority as a continuation application under 35 U.S.C. §120 to PCT/FI2013/050946 filed as an International Application on Sep. 30, 2013 designating the U.S., the entire content of which is hereby incorporated by reference in its entirety.

### FIELD

The present disclosure relates to a cutting device for cutting piles and to a method for cutting piles. A cutting device is disclosed for cutting for example concrete piles, the cutting device being connected to a working machine.

### BACKGROUND INFORMATION

Piling is a common land reclamation technology and foundation practice to direct heavy load of a structure to solid soil, for example to bedrock. Nowadays piling most often uses steel concrete or steel pipe piles, which stand better than for example wood pilings, and which are rot-proof in the ground.

The number of piles in a building site depends naturally on area of the building to be constructed. Bridge or road construction sites can involve, for example, approximately 300 piles. For example in a middle size flat building site approximately 150 piles are used to pile the groundwork. The length of a single concrete pile is 3-15 meters, and if a need arises it can be lengthened. In the end of the piling work, the pile standing in the ground surface has to be cut to a suitable length in order to continue with other construction site work.

Cutting of the pile is performed as a separate work process in the construction site, and the cutting is commonly performed by a separate cutting unit, which is ordered to construction sites in order to cut the piles. Cutting of a pile is physically very demanding work, which involves manual work phases. In a known method cutting of the piles is performed by first digging ground around the piles so that it is possible to measure a cutting height of the piles in order to perform the cutting work of the piles in the next work phase. The cutting is performed by sawing and by wedging the pile in two, and then an excavator collects upper parts of the piles to carry them away from the construction site. After this, the ground surface is drained and ballasted for forming of a foundry.

Because the piles are often cut in an amount of 30-80 piles, the cutting work phases have to performed for example 7-10 times in a construction site of 300 piles, which takes time and is expensive, because meanwhile other work cannot be performed before the cutting work phases have been finalized. Both a measure man and pile cutter have to perform their work in watery and sinking excavation, that has certain work safety problems.

It could be possible to perform draining and ballasting before cutting of the piles to enhance work safety, but then the cutting level is too near (usually about 5 cm) the ballast surface, which makes cutting more difficult or even impossible, because known cutting of piles requires about 10 cm of cutting level from the ground surface. There are often also piles to be cut near excavators or so high that it is in practice impossible to perform cutting of piles. It can also be impossible to perform cutting of piles due to too watery, slippery and/or sinking excavators or due to less than 10 cm cutting level.

After sawing the final breaking of piles in two parts is performed according to known techniques with a prior art by a wedge and by a sledgehammer. This work phase is physically demanding and requires separate tools.

Document WO2004070120 A1 presents one known cutting device connectable to a working machine in order to cut piles. The cutting device presented in this document includes a body part connected to a moveable boom, and gripping means are arranged to the body part in order to grip the pile to be cut, and a circulating cross-section wafer-like cutoff tool in order to cut the pile. Unfortunately this application has disadvantages. Because the cutoff tool is not directly connected to the gripping means, and because only one cutoff tool is used to cut the pile, tensions can arise to the pile to be cut during cutting, which tensions may damage the cutoff tool. Furthermore only one grip is accomplished by the gripping means of the cutting device disclosed in this document, the grip being used to hold on the pile during cutting and to lift the cut pile part away, which may cause tensions to the cutoff tool of the cutting device damaging the cutoff tool or disturbing the cutoff operation.

### SUMMARY

A cutting device is disclosed for performing work actions to a pile, the cutting device comprising: a body part having means for connecting the cutting device to a working machine; gripping means to obtain a grip of the pile, said gripping means having at least two opposite gripping parts to obtain a grip from different sides of the pile; sawing means to perform a sawing action; joint points of the opposite gripping parts, a distance between said joint points being alterable; means for moving said gripping parts by altering the distance between the joint points of the gripping parts to obtain desired contact areas between the gripping parts and the pile; and elastic means to adapt to forces which arise during sawing movement of the sawing means, and to accomplish sawing movement which also deviates from a longitudinal sawing movement, said elastic means adapting to forces which arise during the sawing movement of the sawing means in order to inhibit damage to the sawing means.

A method for performing work actions to a pile is also disclosed, the method comprising: connecting a cutting device to a working machine, and gripping of the pile by at least two opposite gripping parts from different sides of the pile; altering a distance between joint points of the opposite gripping parts in order to move said gripping parts to obtain desired contact areas between the gripping parts and the pile; using elastic means to adapt to forces which arise during sawing movement of the sawing means; and accomplishing a sawing movement which deviates from a longitudinal sawing movement, and is adapted by said elastic means to forces which arise during the sawing movement to the sawing means in order to inhibit damage to the sawing means.

### BRIEF DESCRIPTION OF THE DRAWINGS

FIG. 1 presents a structure of an exemplary cutting device;

FIG. 2 presents a structure of an exemplary cutting device;

FIG. 3 presents first exemplary embodiment as disclosed herein;

FIG. 4 presents a situation according to the first exemplary embodiment, in which situation contact surfaces of the gripping parts locate at the most far corners of the pile;

FIG. 5 presents a situation according to the first exemplary embodiment, in which situation contact surfaces of the gripping parts locate at the nearest corners of the pile; and

FIG. 6 presents a second exemplary embodiment as disclosed herein.

### DETAILED DESCRIPTION

A cutting device is disclosed which adapts according to a working situation to piles of different diameters and forms in order to handle them easily in cutting or crashing work flows. This is achieved by a cutting device for performing work actions to a pile, the cutting device having a body part, which includes means for connecting the cutting device to a working machine, and the cutting device having gripping means to obtain a grip of the pile, the gripping means having at least two opposite gripping parts to obtain a grip from different sides of the pile, and the cutting device having sawing means to perform a sawing action. The cutting device includes joint points of the opposite gripping parts, a distance between the joint points being alterable, and means for moving the gripping parts by altering the distance between the joint points of the gripping parts to obtain desired contact areas between the gripping parts and the pile.

A method is disclosed for performing work actions to a pile, in which a cutting device is connected to a working machine, and obtains a grip of the pile by at least two opposite gripping parts from different sides of the pile. In the method, a distance between joint points of the opposite gripping parts is altered in order to move the gripping parts to obtain desired contact areas between the gripping parts and the pile.

Exemplary embodiments include joint points of the opposite gripping parts for performing gripping part movements of a cutting device, and a distance between the joint points is alterable so that the gripping parts can be moved by altering the distance between the joint points of the gripping parts to move contact areas of the gripping parts to desired positions between the gripping parts and the pile.

An exemplary benefit is that a contact area between the gripping parts and the pile can be changed by controlling a distance between the gripping parts enabling strong pressing in a base area near the joint point. By this, one pair of gripping parts can be used to move piles by using heads of the gripping parts, and a pile can be caught by middle parts of the gripping parts, and by using the base areas of the gripping parts a strong, even crushing pressing can be achieved. Another exemplary benefit is that cutting and crushing actions can be performed by the cutting device faster and safer than in known embodiments.

As referenced herein, the term “pile” related to this disclosure can mean many kinds of piles used in pilework into ground, for example steel-armoured concrete piles, steel piles, wood piles, micro piles, in situ piles, and other piles used for reformation of soil and for supporting of ground. Length and thickness of the piles can vary, and they can have rectangular, circular, or some other shape in cross section.

The term “working machine” as referenced herein can mean many kinds of working machines used in building or construction sites, such as for example an excavator, a pile-driver, a tractor and different kinds of cranes having a lifting and descending boom. The working machine includes utensils integrated to the working machine or utensils, which are connected to the working machine. The utensils can be for example a hydraulic unit supplying power to the cutting device according to the present disclosure to move the boom of the working machine.

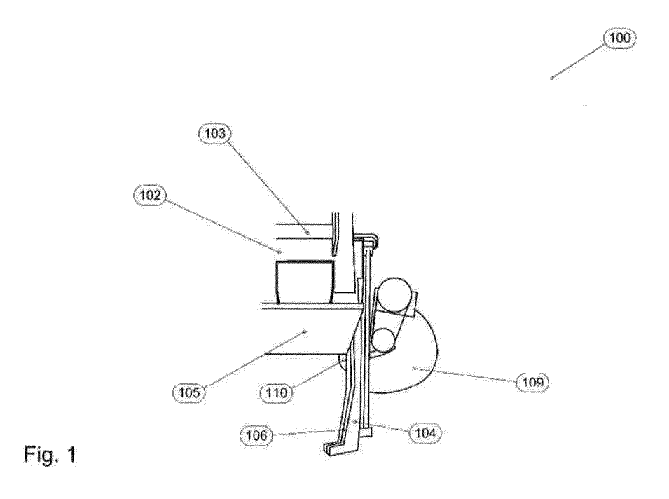

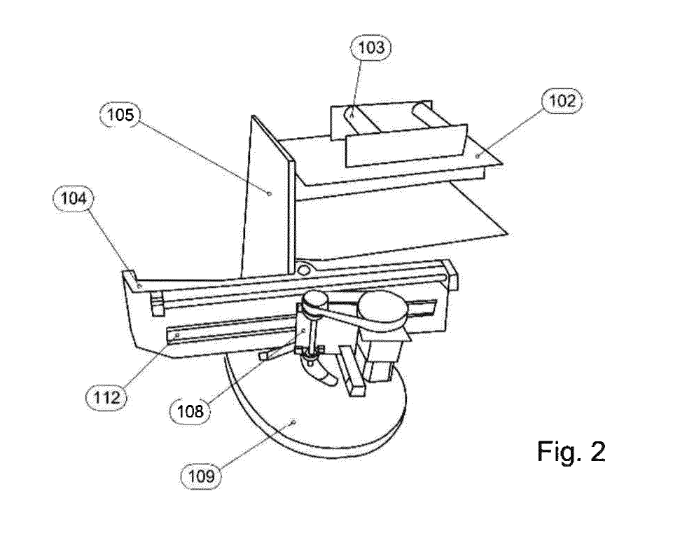

FIGS. 1 and 2 present an exemplary cutting device for cutting a pile which includes a body part 102, which has means 103 for connecting the cutting device to a working machine, gripping means 104 having at least two opposite gripping parts 106, and sawing parts 108 having sawing means 110 connected to the sawing parts 108.

The cutting device 100 can be manufactured of longstanding material, such as for example of steel or iron, to obtain pressure force of the gripping means 104 that is strong enough to lift cut pile part away. The cutting device is so manufactured that total weight of the cutting device makes the cutting device lightweight and easy to handle.

A control plate 105 can be coordinated with the body part 102, which control plate is positioned against the pile to be cut, when the cutting device is driven round the pile. The body part 102 can also include connecting means 103 to connect the cutting device to a working machine. According to an exemplary embodiment the connecting means 103 are for example at least one tie rod to connect the cutting device to a boom of the working machine. A shape and size of the connecting means 103 can vary depending on which type of working machine the cutting device is to be connected. In an exemplary embodiment the connecting means 103 are arranged to be quickly opened for example by some kind of a quick release fastener arrangement. Furthermore according to an exemplary embodiment the connecting means 103 are so arranged that the cutting device 100 can be partly released from the working machine for example by wire rope(s) or cable(s) or by some other suitable means, which enable the cutting device to move freely and also enable the cutting device to be quickly connected back to the working machine from said partly released operation condition.

The gripping means 104 are for example connected to the control plate 105. In some embodiments also other parts of the cutting device can be located in the body part 102. These other parts can be for example means for operating the cutting device, such as hydraulic means, pneumatic means and/or electric motor(s).

The cutting device according to exemplary embodiments can be attached to many kind of working machines used in building or construction sites depending on the embodiment, such as for example an excavator, a pile-driver, a tractor and different kinds of cranes comprising a lifting and descending boom. It will be apparent to a person skilled in the art that the cutting device can be connected also to other kind of machines or devices having a boom to move the cutting device near a pile to be cut and to lift the cut pile part away.

In the embodiments according to FIGS. 1 and 2 the gripping means 104 includes at least two opposite gripping parts 106 to obtain a grip from the pile to be cut to hold on to the pile so that the pile is between the gripping parts 106. The gripping means can be arranged to obtain a grip from the pile to be cut to hold on to the pile during cutting, to obtain a grip from the pile to lift the cut pile away, and to release the gripping means 104 from the grips. In the embodiments in which there are arranged more than single opposite gripping parts to the gripping means, first gripping parts can be arranged to obtain a grip from the pile to be cut to hold on to the pile during cutting, and second gripping parts can be arranged to obtain a grip from the pile to lift the cut pile part away. Then the gripping parts can be arranged within each other or in layers.

In an exemplary embodiment according to the disclosure maximum distance between the gripping parts is controllable on the basis of the pile type or pile size to be cut. Distance between the gripping parts can be changed by using for example mechanical means or hydraulic means to perform necessary movements. This kind of distance control can be performed by control means arranged to the cutting device according to the disclosure, the control means being for example mechanical or hydraulic means for controlling distance of the gripping parts of the griping means. In an exemplary embodiment the control means can be arranged to control distance of the joints between the gripping parts 104 and body part of the cutting device so that said distance becomes suitable to piles of different diameters.

In an exemplary embodiment sawing parts 108 can be attached to the gripping parts 106 of the gripping means 104. In an exemplary embodiment the sawing parts 108 can be arranged below the gripping parts 106, for example 1 cm-2 cm from a lower edge of the gripping part. This enables sawing means of the sawing parts to perform sawing of a pile very near ground surface. Ground clearance of the cutting device is for example 2 cm-8 cm, and most preferably about, for example, 3 cm-5 cm. Height of the gripping means can vary much depending on the embodiment, but for example the gripping parts are made high enough for example to enable attachment of rails to the gripping parts, the rails being for the reciprocating movement of the sawing means. Height of the gripping parts can be for example about 5 cm-45 cm, and preferably for example about 20 cm-25 cm, which enables for example fastening of the rails to the gripping parts. Height of the pile to be cut is to be at least for example about 2 cm-7 cm, and preferably for example, at least about 3 cm-5 cm, so that the gripping parts of the device according to the present disclosure obtain a tight grip of the pile to be cut, and the pile can be cut.

The sawing part 110 is arranged to move substantially longitudinally back and forth as to the gripping parts of the gripping means when the sawing part 108 is in a sawing position. In the embodiments of FIGS. 1 and 2 the movements are arranged by rails 112 and a screwing rod 118 by control of which the sawing part is arranged to the reciprocating motion in the sawing position along a lower part of the gripping means for example by a hydraulic motor or by an electric motor. It will be apparent to a person skilled in the art that the movements of the sawing part can be arranged also by other means such as instead of the rails can be used bearing-mounted wheels and an open channel section, which is opened on one side, the arrangement thus accomplishing a rail like structure enabling the sawing part to move longitudinally. The screwing rod to move the sawing part can be replaced for example by cable operated or chain driven operation or by using hydraulic or pneumatic cylinders.

The sawing means 110 are for example arranged to the sawing part by a sprung rebound rod so that that the sawing part 108 protects the sawing means 110 for example by covers 109 located on upper and/or below a side of the sawing part 108, the covers preventing other objects from getting in touch with the sawing means. The sawing means can include all possible means to saw steel or reinforced concrete such as for example a diamond wheel, a chain saw with diamond segments, water cutting methods, chipping drilling cutting and a hard burr. Especially cutting of circular steel pipe piles is for example performed by a hard burr similar as the sawing means, because it does not cause sparkles during the cutting.

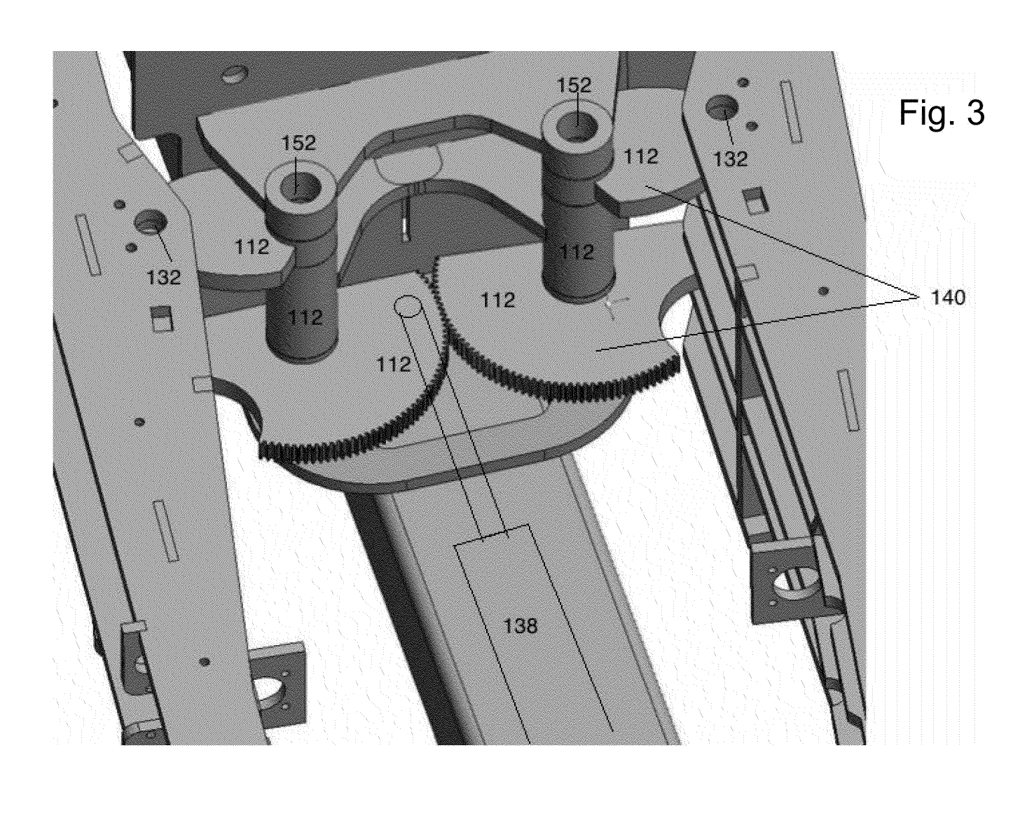

In an exemplary embodiment the sawing part is arranged to the reciprocating motion in the sawing position for example along a gripping part 106 of the gripping means 104. The sawing means are activated at the same time. Depending on the embodiment the cutting device can include for example a hydraulic or a pneumatic motor to supply the use of the sawing means 110. It will be apparent to a person skilled in the art that also other kinds of suitable means can be used to provide the operation of the sawing means. As presented in the embodiment of FIG. 3 the motor used by the sawing means 110 is for example attached to the sawing part 108.

An exemplary embodiment according to the present disclosure can use elastic means 114, which prevent powerful pressing or hit force from directing to the sawing means and thus prevent the sawing means from damage. The elastic means 114 are adapted to the sawing means so that they allow the sawing means to move away as to the gripping means, which means in an exemplary embodiment into the sawing part 108, and the elastic means 114 return the sawing means to sawing position, when force targeted to the sawing means is less than for example about 50 N-150 N, and preferably, for example, about 70 N-100 N. Then cutting of the pile is performed only by reciprocating movement of the sawing part 108 and by sawing movement of the sawing means, which is for example circling movement of a diamond wheel, and the sawing means are prevented from damage during cutting operation. When other than the diamond wheel is used as the sawing means, for example a hard fragment wheel or a fibre wheel, which are especially used for cutting round piles or pipes, force targeted to the sawing means can be less than presented above, for example about 30 N or more. The used elastic means can vary depending on the embodiment, but for example can include a pushing and/or pulling mechanical spring or gas spring. It will be apparent for a person skilled in the art, that as elastic means can be used also some other suitable means.

According to an exemplary embodiment, to the gripping means is further arranged inductive detectors and/or according to another embodiment to the body part is further arranged a detector, and on the basis of the detectors can be detected, when the sawing means have reached maximum depth in the pile to be cut, and the sawing can be stopped. Also to the sawing means can be arranged detectors to detect extreme positions of the sawing means so that they will not touch.

In FIG. 3 is presented a first exemplary embodiment according to the present disclosure, in which the cutting device includes joint points 132 of the opposite gripping parts 106, a distance between the joint points being alterable, and means 112 for moving the gripping parts 106 by altering the distance between the joint points 132 of the gripping parts so that contact surfaces of the gripping parts are moved to desired locations between the gripping part and the pile. These desired locations can be for example accomplishing a tight grip by large contact surfaces in sawing or lifting operations of the pile or accomplishing a crushing grip by small contact surfaces to corner areas of an angulated pile to perform crushing operation of the pile. In the embodiment of FIG. 3 the means 112 are a pair of gears 112a positioned eccentrictly as to the joint points of the gripping parts 106, the pair of gears being arranged in a structure 140 of at least one layer, for example, in a structure 140 of two layers. Movement control of the pair of gears 112a of the opposite gripping parts is for example performed by at least one hydraulic cylinder 138 to a rotation circle turning a centre axis of the gear.

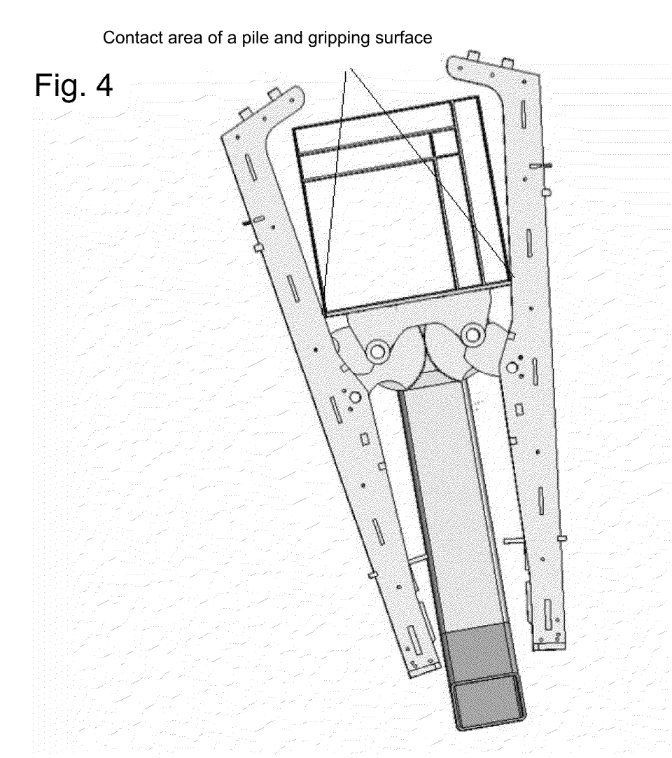

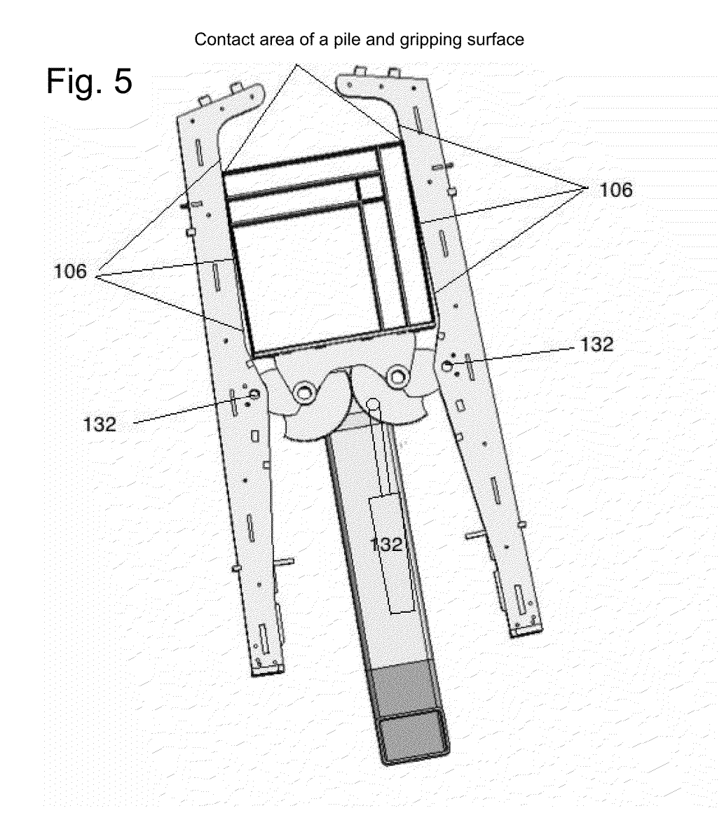

In FIG. 4 is presented a situation according to the first embodiment, in which situation the contact surfaces of the gripping parts 106 are in the most far corners of the pile. In FIG. 5 is presented a situation according to the present disclosure, in which situation the contact surfaces of the gripping parts 106 locate at the nearest corners of the pile in bases of the gripping parts 106 near the joint points 132.

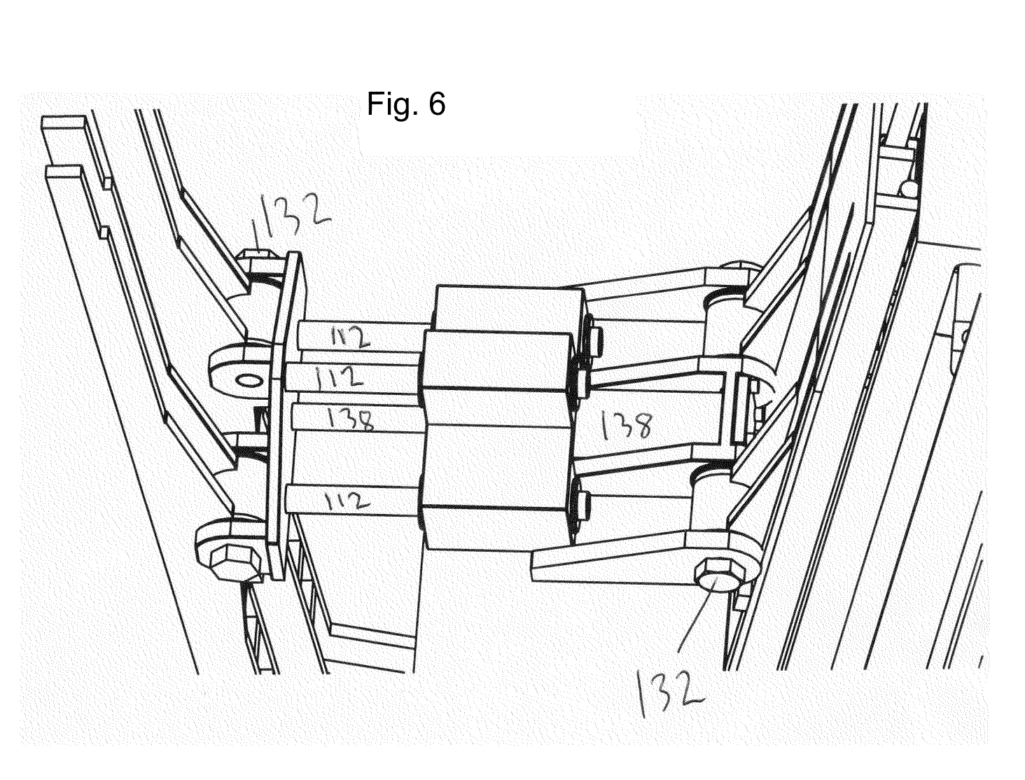

In an embodiment presented in FIG. 6 the means 112 for moving the gripping parts 106 by altering the distance between the joint points 132 of the gripping parts are rails 112b on which movements are performed, and at least one cylinder 138 to control the movements. Movement control of the opposite gripping parts along rails 112 for example is performed by at least one hydraulic cylinder 138, but also a two headed cylinder can be used.

Exemplary embodiments according to the disclosure can also use elastic means 114 to determine an optimal pushing force between the sawing means and the pile to be cut both in order to adapt to forces, which arise during the sawing movement of the sawing means 110, and to accomplish sawing movement which also deviates from the longitudinal sawing movement.

The elastic means 114 are arranged to adapt to forces which arise during the sawing movement of the sawing means 110 in order to prevent the sawing means from damage. Especially in an essentially stationary sawing operation the elastic means 114 control pushing force of the sawing means 110 towards sawing surface, and can accomplish sawing movement which deviates from the longitudinal direction. In exemplary embodiments according to the disclosure the cutting device 100 can include also measurement means integrated to the cutting device for determining diameter of the pile and to change distance between the gripping parts 106 suitable for the determined diameter of the pile. The measurement means can be accomplished for example by optical measurement sensors.

In an exemplary embodiment grip force, which is accomplished to the pile by the contact surfaces of the gripping parts, can be regulated for example according to the pile part to be lifted or to be crushed. The regulation can be arranged to be performed by the user, where the user determines the needed grip force, or the regulation can be arranged automatically for example by sensor and control arrangement in the device. In an exemplary embodiment in the device can be also second gripping means and their gripping parts in order to make sure the grip is achieved, especially for a long pile.

Embodiments according to the disclosure can be accomplished also by other technical structures than presented above. In addition to the gear and rail embodiments , the means 112 for moving the gripping parts 106 by altering the distance between the joint points 132 of the gripping parts 106 can be accomplished also by some other suitable means. Also as the control means can be used some other suitable means than the above presented cylinder embodiments. The control means, such as for example the at least one cylinder 138, can be controlled for example via a wired or wireless control connection for example from a control stick in a cab of the working machine.

Above is presented exemplary embodiments according to the present invention. The principles according to the invention can be varied in the scope determined by the patent claims for example by details of the embodiments and by different applications.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A cutting device for performing work actions to a pile, the cutting device comprising:
a body part having means for connecting the cutting device to a working machine;
gripping means to obtain a grip of the pile, said gripping means having at least two opposite gripping parts to obtain a grip from different sides of the pile;
sawing means to perform a sawing action;
joint points of the opposite gripping parts, a distance between said joint points being alterable;
means for moving said gripping parts by altering the distance between the joint points of the gripping parts to obtain desired contact areas between the gripping parts and the pile; and
elastic means to adapt to forces which arise during sawing movement of the sawing means, and to accomplish sawing movement which also deviates from a longitudinal sawing movement, said elastic means adapting to forces which arise during the sawing movement of the sawing means in order to inhibit damage to the sawing means.

2. A cutting device according to the claim 1, wherein the elastic means are configured for controlling pushing force of the sawing means towards a sawing surface and for accomplishing a sawing movement which also deviates from the longitudinal sawing movement.

3. A cutting device according to the claim 1, wherein the means for moving said gripping parts by altering the distance between the joint points of the gripping parts comprises:
a pair of gears positioned eccentrictly as to the joint points of the gripping parts, said pair of gears being arranged in a structure of two layers, and at least one cylinder to control the pair of gears.

4. A cutting device according to the claim 1, wherein the means for moving said gripping parts by altering the distance between the joint points of the gripping parts comprises:
rails on which movements are performed, and at least one cylinder to control said movements.

5. A cutting device according to the claim 1, comprising:
measurement means integrated to the cutting device for determining a diameter of the pile and to change distance between the gripping parts suitable for the determined diameter of the pile.

6. A method for performing work actions to a pile, the method comprising:
connecting a cutting device to a working machine, and gripping of the pile by at least two opposite gripping parts from different sides of the pile;
altering a distance between joint points of the opposite gripping parts in order to move said gripping parts to obtain desired contact areas between the gripping parts and the pile;
using elastic means to adapt to forces which arise during sawing movement of the sawing means; and
accomplishing a sawing movement which deviates from a longitudinal sawing movement, and is adapted by said elastic means to forces which arise during the sawing movement to the sawing means in order to inhibit damage to the sawing means.

7. A method according to the claim 6, comprising:
controlling pushing force of the sawing means towards sawing surface; and
accomplishing a sawing movement which also deviates from the longitudinal sawing movement.

8. A method according to the claim 6, comprising:
moving said gripping parts by altering the distance between the joint points of the gripping parts by using a pair of gears positioned eccentrictly as to the joint points of the gripping parts, said pair of gears being arranged in a structure of two layers; and
controlling, by at least one cylinder, the pair of gears.

9. A method according to the claim 6, comprising:
altering the distance between the joint points of the gripping parts by cylinder control along rails.

10. A method according to the claim 6, comprising:
determining as integrated to the cutting device operation a diameter of the pile; and
changing a distance between the gripping parts suitable for the determined diameter of the pile.
